(19) United States
(12) Patent Application Publication
(10) Pub. No.: US 2011/0206565 A1
(43) Pub. Date: Aug. 25, 2011

(54) CHEMICAL REACTORS WITH RE-RADIATING SURFACES AND ASSOCIATED SYSTEMS AND METHODS

(75) Inventor: Roy Edward McAlister, Phoenix, AZ (US)

(73) Assignee: McAlister Technologies, LLC, Phoenix, AZ (US)

(21) Appl. No.: 13/027,015

(22) Filed: Feb. 14, 2011

Related U.S. Application Data
(60) Provisional application No. 61/304,403, filed on Feb. 13, 2010.

(51) Int. Cl. B01J 19/08; C09K 3/00

(52) U.S. Cl. 422/186; 252/183.11

(57) ABSTRACT

Chemical reactors with re-radiating surfaces and associated systems and methods. A reactor in accordance with a particular embodiment includes a reactor vessel having a reaction zone, and a reactant supply coupled to the reactor vessel to direct a reactant (e.g., a hydrogen donor) into the reaction zone. The reactant has a peak absorption wavelength range over which it absorbs more energy than at non-peak wavelengths. The reactor further includes a re-radiation component positioned at the reaction zone to receive radiation over a first spectrum having a first peak wavelength range, and re-radiate the radiation into the reaction zone over a second spectrum having a second peak wavelength range different than the first, and closer than the first to the peak absorption range of the reactant.

### CROSS-REFERENCE TO RELATED APPLICATIONS

The present application claims priority to and the benefit of U.S. Patent Application No. 61/304,403, filed on Feb. 13, 2010 and titled FULL SPECTRUM ENERGY AND RESOURCE INDEPENDENCE, which is incorporated herein by reference in its entirety. To the extent the foregoing application and/or any other materials incorporated herein by reference conflict with the disclosure presented herein, the disclosure herein controls.

### TECHNICAL FIELD

The present technology relates generally to chemical reactors with re-radiating surfaces and associated systems and methods. In particular embodiments, reactor systems with re-radiating surfaces can be used to produce clean-burning, hydrogen-based fuels from a wide variety of feedstocks, and can produce structural building blocks from carbon and/or other elements that are released when forming the hydrogen-based fuels.

### BACKGROUND

Renewable energy sources such as solar, wind, wave, falling water, and biomass-based sources have tremendous potential as significant energy sources, but currently suffer from a variety of problems that prohibit widespread adoption. For example, using renewable energy sources in the production of electricity is dependent on the availability of the sources, which can be intermittent. Solar energy is limited by the sun's availability (i.e., daytime only), wind energy is limited by the variability of wind, falling water energy is limited by droughts, and biomass energy is limited by seasonal variances, among other things. As a result of these and other factors, much of the energy from renewable sources, captured or not captured, tends to be wasted.

The foregoing inefficiencies associated with capturing and saving energy limit the growth of renewable energy sources into viable energy providers for many regions of the world, because they often lead to high costs of producing energy. Thus, the world continues to rely on oil and other fossil fuels as major energy sources because, at least in part, government subsidies and other programs supporting technology developments associated with fossil fuels make it deceptively convenient and seemingly inexpensive to use such fuels. At the same time, the replacement cost for the expended resources, and the costs of environment degradation, health impacts, and other by-products of fossil fuel use are not included in the purchase price of the energy resulting from these fuels.

In light of the foregoing and other drawbacks currently associated with sustainably producing renewable resources, there remains a need for improving the efficiencies and commercial viabilities of producing products and fuels with such resources.

### BRIEF DESCRIPTION OF THE DRAWINGS

FIG. 1 is a partially schematic, partially cross-sectional illustration of a system having a reactor with a re-radiation component in accordance with an embodiment of the presently disclosed technology.

FIG. 2 illustrates absorption characteristics as a function of wavelength for a representative reactant and re-radiation material, in accordance with an embodiment of the presently disclosed technology.

FIG. 3 is an enlarged, partially schematic illustration of a portion of the reactor shown in FIG. 1 having a re-radiation component configured in accordance with a particular embodiment of the presently disclosed technology.

FIG. 4 is an enlarged, partially schematic illustration of a portion of the reactor shown in FIG. 2 having a re-radiation component configured in accordance with another embodiment of the presently disclosed technology.

FIG. 5 is an enlarged, partially schematic illustration of a portion of the reactor shown in FIG. 2 having a reflective re-radiation component configured in accordance with still another embodiment of the presently disclosed technology.

### DETAILED DESCRIPTION

### 1. Overview

Several examples of devices, systems and methods for shifting, tuning or otherwise re-radiating radiation energy in a chemical reactor are described below. Such reactors can be used to produce hydrogen fuels and/or other useful end products. Accordingly, the reactors can produce clean-burning fuel and can re-purpose carbon and/or other constituents for use in durable goods, including polymers and carbon composites. Although the following description provides many specific details of the following examples in a manner sufficient to enable a person skilled in the relevant art to practice, make and use them, several of the details and advantages described below may not be necessary to practice certain examples of the technology. Additionally, the technology may include other examples that are within the scope of the claims but are not described here in detail.

References throughout this specification to “one example,” “an example,” “one embodiment” or “an embodiment” mean that a particular feature, structure, process or characteristic described in connection with the example is included in at least one example of the present technology. Thus, the occurrences of the phrases “in one example,” “in an example,” “one embodiment” or “an embodiment” in various places throughout this specification are not necessarily all referring to the same example. Furthermore, the particular features, structures, routines, steps or characteristics may be combined in any suitable manner in one or more examples of the technology. The headings provided herein are for convenience only and are not intended to limit or interpret the scope or meaning of the claimed technology.

Certain embodiments of the technology described below may take the form of computer-executable instructions, including routines executed by a programmable computer or controller. Those skilled in the relevant art will appreciate that the technology can be practiced on computer or controller systems other than those shown and described below. The technology can be embodied in a special-purpose computer, controller, or data processor that is specifically programmed, configured or constructed to perform one or more of the computer-executable instructions described below. Accordingly, the terms “computer” and “controller” as generally used herein refer to any data processor and can include internet appliances, hand-held devices, multi-processor systems, programmable consumer electronics, network computers, mini-computers, and the like. The technology can also be practiced in distributed environments where tasks or modules are performed by remote processing devices that are linked through a communications network. Aspects of the technology described below may be stored or distributed on computer-readable media, including magnetic or optically readable or removable computer discs as well as media distributed electronically over networks. In particular embodiments, data structures and transmissions of data particular to aspects of the technology are also encompassed within the scope of the present technology. The present technology encompasses both methods of programming computer-readable media to perform particular steps, as well as executing the steps.

A chemical reactor in accordance with a particular embodiment includes a reactor vessel having a reaction zone. A reactant supply is coupled to the reactor vessel to direct a reactant into the reaction zone. The reactant has a peak absorption wavelength range over which it absorbs more energy than at non-peak wavelengths. A re-radiation component is positioned at the reaction zone to receive radiation over a first spectrum having a first peak wavelength range, and re-radiate the radiation into the reaction zone over a second spectrum having a second peak wavelength range different than the first. The second peak wavelength range is closer than the first to the peak absorption wavelength of the reactant. Accordingly, the re-radiation function performed by the re-radiation component can enhance the efficiency with which energy received by the reactant is used to complete the reaction in the reactor vessel.

A representative chemical process in accordance with an embodiment of the disclosure includes directing chemical reactants into a reaction zone, with the chemical reactants including a hydrogen donor, and with at least one of the reactants having a peak absorption wavelength range over which it absorbs more energy than at non-peak wavelengths. The method further includes absorbing radiation over a first spectrum having a first peak wavelength range, and re-radiating the radiation into the reaction zone over a second spectrum having a second peak wavelength range different than the first and closer than the first to the peak absorption wavelength range of the reactant.

Further aspects of the technology are directed to methods for manufacturing a chemical reactor. One such method includes selecting chemical reactants for use in a reaction chamber to include a hydrogen donor, with at least one of the reactants and/or a resulting product having a peak absorption wavelength range over which it absorbs more energy than at non-peak wavelengths. The method can further include selecting a re-radiation component positioned at the reaction zone to receive radiation over a first spectrum having a first peak wavelength range and re-radiate the radiation over a second spectrum having a second peak wavelength range different than the first and closer than the first to the peak absorption wavelength range of the reactant. This technique for designing and manufacturing the reactor can produce a reactor with the enhanced thermal efficiencies described above.

### 2. Representative Reactors and Associated Methodologies

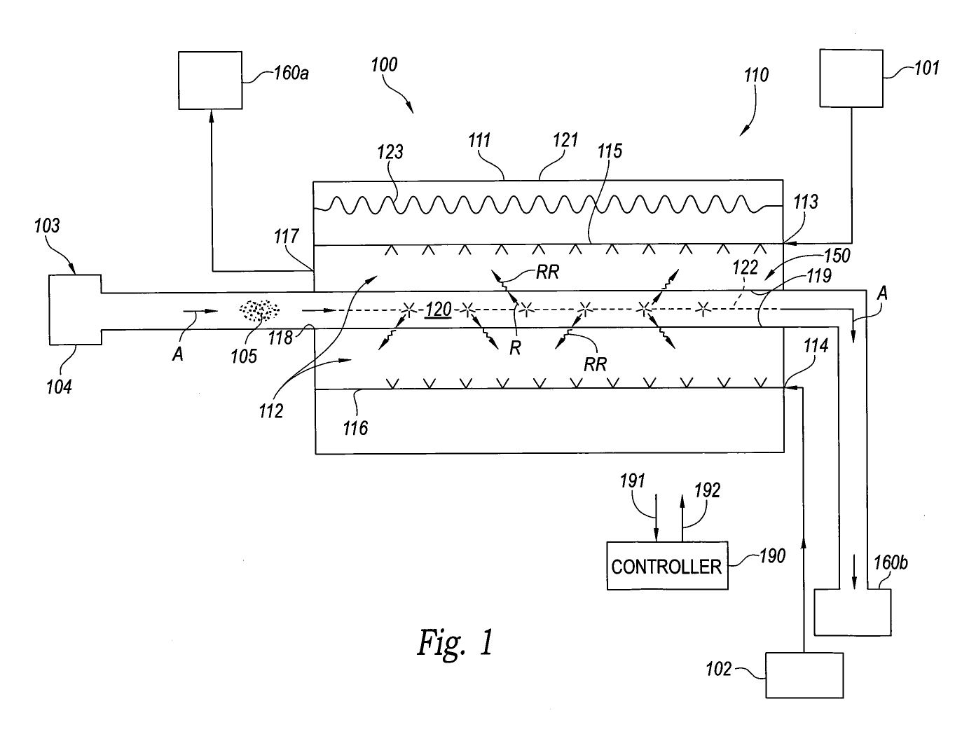

FIG. 1 is a partially schematic illustration of a system 100 that includes a reactor 110. The reactor 110 further includes a reactor vessel 111 having an outer surface 121 that encloses or partially encloses a reaction zone 112. The reactor vessel 111 has one or more re-radiation components positioned to facilitate the chemical reaction taking place within the reaction zone 112. In a representative example, the reactor vessel 111 receives a hydrogen donor provided by a donor source 101 to a donor entry port 113. For example, the hydrogen donor can include methane or another hydrocarbon. A donor distributor or manifold 115 within the reactor vessel 111 disperses or distributes the hydrogen donor into the reaction zone 112. The reactor vessel 111 also receives steam from a steam/water source 102 via a steam entry port 114. A steam distributor 116 in the reactor vessel 111 distributes the steam into the reaction zone 112. The reactor vessel 111 can still further include a heater 123 that supplies heat to the reaction zone 112 to facilitate endothermic reactions. Such reactions can include dissociating methane or another hydrocarbon into hydrogen or a hydrogen compound, and carbon or a carbon compound. The products of the reaction (e.g., carbon and hydrogen) exit the reactor vessel 111 via an exit port 117 and are collected at a reaction product collector 160a.

The system 100 can further include a source 103 of radiant energy and/or additional reactants, which provides constituents to a passage 118 within the reactor vessel 111. For example, the radiant energy/reactant source 103 can include a combustion chamber 104 that provides hot combustion products 105 to the passage 118, as indicated by arrow A. In a particular embodiment, the passage 118 is concentric relative to a passage centerline 122. In other embodiments, the passage 118 can have other geometries. A combustion products collector 160b collects combustion products exiting the reactor vessel 111 for recycling and/or other uses. In a particular embodiment, the combustion products 105 can include carbon monoxide, water vapor, and other constituents.

One or more re-radiation components 150 are positioned between the reaction zone 112 (which can be disposed annularly around the passage 118) and an interior region 120 of the passage 118. The re-radiation component 150 can accordingly absorb incident radiation R from the passage 118 and direct re-radiated energy RR into the reaction zone 112. The re-radiated energy RR can have a wavelength spectrum or distribution that more closely matches, approaches, overlaps and/or corresponds to the absorption spectrum of at least one of the reactants and/or at least one of the resulting products. By delivering the radiant energy at a favorably shifted wavelength, the system 100 can enhance the reaction taking place in the reaction zone 112, for example, by increasing the efficiency with which energy is absorbed by the reactants, thus increasing the reaction zone temperature and/or pressure, and therefore the reaction rate, and/or the thermodynamic efficiency of the reaction. In a particular aspect of this embodiment, the combustion products 105 and/or other constituents provided by the source 103 can be waste products from another chemical process (e.g., an internal combustion process). Accordingly, the foregoing process can recycle or reuse energy and/or constituents that would otherwise be wasted, in addition to facilitating the reaction at the reaction zone 112.

In at least some embodiments, the re-radiation component 150 can be used in conjunction with, and/or integrated with, a transmissive surface 119 that allows chemical constituents (e.g., reactants) to readily pass from the interior region 120 of the passage 118 to the reaction zone 112. Further details of representative transmissive surfaces are disclosed in co-pending U.S. application Ser. No. ______ titled “REACTOR VESSELS WITH TRANSMISSIVE SURFACES FOR PRODUCING HYDROGEN-BASED FUELS AND STRUCTURAL ELEMENTS, AND ASSOCIATED SYSTEMS AND METHODS” (Attorney Docket No. 69545.8602US), filed concurrently herewith and incorporated herein by reference. In other embodiments, the reactor 110 can include one or more re-radiation components 150 without also including a transmissive surface 119. In any of these embodiments, the radiant energy present in the combustion product 105 may be present as an inherent result of the combustion process. In other embodiments, an operator can introduce additives into the stream of combustion products 105 (and/or the fuel that produces the combustion products) to increase the amount of energy extracted from the stream and delivered to the reaction zone 112 in the form of radiant energy. For example, the combustion products 105 (and/or fuel) can be seeded with sources of sodium, potassium, and/or magnesium, which can absorb energy from the combustion products 105 and radiate the energy outwardly into the reaction zone 112 at desirable frequencies. These illuminant additives can be used in addition to the re-radiation component 150.

The system 100 can further include a controller 190 that receives input signals 191 (e.g., from sensors) and provides output signals 192 (e.g., control instructions) based at least in part on the inputs 191. Accordingly, the controller 190 can include suitable processor, memory and I/O capabilities. The controller 190 can receive signals corresponding to measured or sensed pressures, temperatures, flow rates, chemical concentrations and/or other suitable parameters, and can issue instructions controlling reactant delivery rates, pressures and temperatures, heater activation, valve settings and/or other suitable actively controllable parameters. An operator can provide additional inputs to modify, adjust and/or override the instructions carried out autonomously by the controller 190.

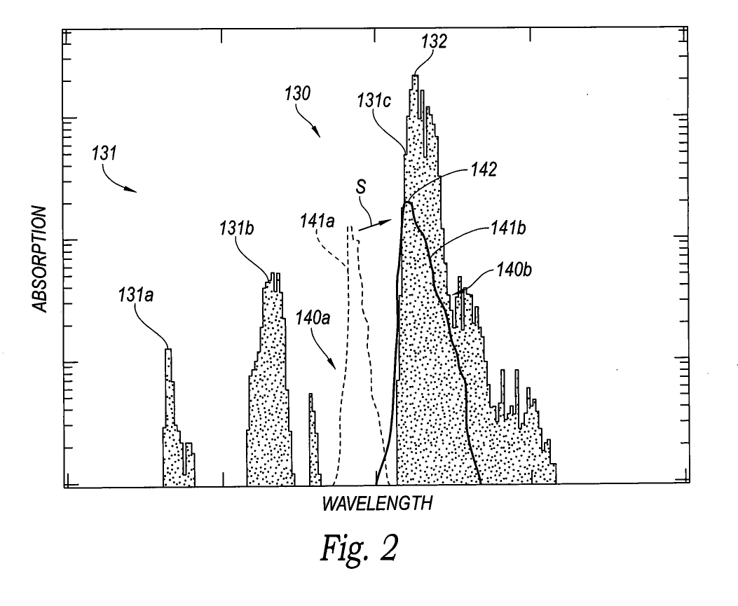

FIG. 2 is a graph presenting absorption as a function of wavelength for a representative reactant (e.g., methane) and a representative re-radiation component. FIG. 2 illustrates a reactant absorption spectrum 130 that includes multiple reactant peak absorption ranges 131, three of which are highlighted in FIG. 2 as first, second and third peak absorption ranges 131a, 131b, 131c. The peak absorption ranges 131 represent wavelengths for which the reactant absorbs more energy than at other portions of the spectrum 130. The spectrum 130 can include a peak absorption wavelength 132 within a particular range, e.g., the third peak absorption range 131c.

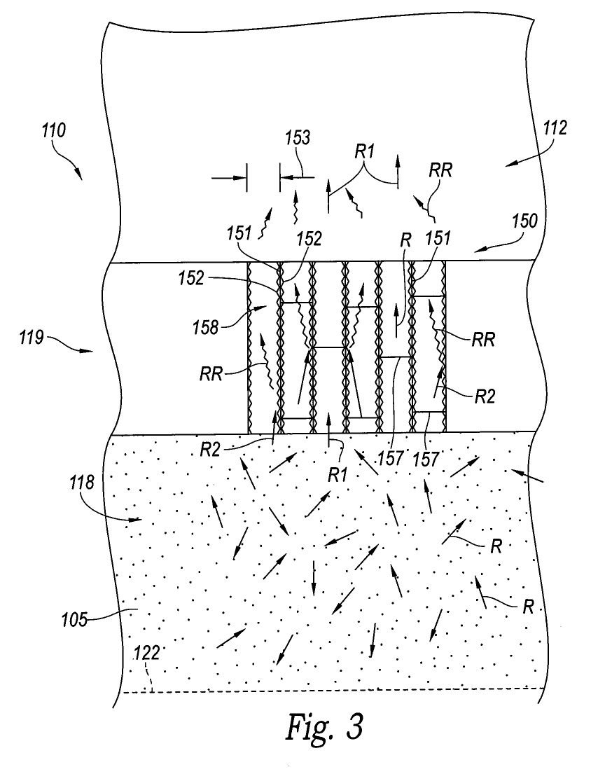

FIG. 2 also illustrates a first radiant energy spectrum 140a having a first peak wavelength range 141a. For example, the first radiant energy spectrum 140a can be representative of the emission from the combustion products 105 described above with reference to FIG. 1. After the radiant energy has been absorbed and re-emitted by the re-radiation component 150 described above, it can produce a second radiant energy spectrum 140b having a second peak wavelength range 141b, which in turn includes a re-radiation peak value 142. In general terms, the function of the re-radiation component 150 is to shift the spectrum of the radiant energy from the first radiant energy spectrum 140a and peak wavelength range 141a to the second radiant energy spectrum 140b and peak wavelength range 141b, as indicated by arrow S. As a result of the shift, the second peak wavelength range 141b is closer to the third peak absorption range 131c of the reactant than is the first peak wavelength range 141a. For example, the second peak wavelength range 141b can overlap with the third peak absorption range 131c and in a particular embodiment, the re-radiation peak value 142 can be at, or approximately at the same wavelength as the reactant peak absorption wavelength 132. In this manner, the re-radiation component more closely aligns the spectrum of the radiant energy with the peaks at which the reactant efficiently absorbs energy. Representative structures for performing this function are described in further detail below with reference to FIGS. 3-5.

FIG. 3 is a partially schematic, enlarged cross-sectional illustration of a portion of the reactor 110 described above with reference to FIG. 1, having a re-radiation component 150 configured in accordance with a particular embodiment of the technology. The re-radiation component 150 is positioned between the passage 118 (and the radiation energy R in the passage 118), and the reaction zone 112. The re-radiation component 150 can include layers 151 of material that form spaced-apart structures 158, which in turn carry a re-radiative material 152. For example, the layers 151 can include graphene layers or other crystal or self-orienting layers made from suitable building block elements such as carbon, boron, nitrogen, silicon, transition metals, and/or sulfur. Carbon is a particularly suitable constituent because it is relatively inexpensive and readily available. In fact, it is a target output product of reactions that can be completed in the reaction zone 112. Further details of suitable structures are disclosed in co-pending U.S. application Ser. No. ______ titled “ARCHITECTURAL CONSTRUCT HAVING FOR EXAMPLE A PLURALITY OF ARCHITECTURAL CRYSTALS” (Attorney Docket No. 69545.8701US) filed concurrently herewith and incorporated herein by reference. Each structure 158 can be separated from its neighbor by a gap 153. The gap 153 can be maintained by spacers 157 extending between neighboring structures 158. In particular embodiments, the gaps 153 between the structures 158 can be from about 2.5 microns to about 25 microns wide. In other embodiments, the gap 153 can have other values, depending, for example, on the wavelength of the incident radiative energy R. The spacers 157 are positioned at spaced-apart locations both within and perpendicular to the plane of FIG. 3 so as not to block the passage of radiation and/or chemical constituents through the component 150.

The radiative energy R can include a first portion R1 that is generally aligned parallel with the spaced-apart layered structures 158 and accordingly passes entirely through the re-radiation component 150 via the gaps 153 and enters the reaction zone 112 without contacting the re-radiative material 152. The radiative energy R can also include a second portion R2 that impinges upon the re-radiative material 152 and is accordingly re-radiated as a re-radiated portion RR into the reaction zone 112. The reaction zone 112 can accordingly include radiation having different energy spectra and/or different peak wavelength ranges, depending upon whether the incident radiation R impinged upon the re-radiative material 152 or not. This combination of energies in the reaction zone 112 can be beneficial for at least some reactions. For example, the shorter wavelength, higher frequency (higher energy) portion of the radiative energy can facilitate the basic reaction taking place in the reaction zone 112, e.g., disassociating methane in the presence of steam to form carbon monoxide and hydrogen. The longer wavelength, lower frequency (lower energy) portion can prevent the reaction products from adhering to surfaces of the reactor 110, and/or can separate such products from the reactor surfaces. In particular embodiments, the radiative energy can be absorbed by methane in the reaction zone 112, and in other embodiments, the radiative energy can be absorbed by other reactants, for example, the steam in the reaction zone 112, or the products. In at least some cases, it is preferable to absorb the radiative energy with the steam. In this manner, the steam receives sufficient energy to be hot enough to complete the endothermic reaction within the reaction zone 112, without unnecessarily heating the carbon atoms, which may potentially create particulates or tar if they are not quickly oxygenated after dissociation.

The re-radiative material 152 can include a variety of suitable constituents, including iron carbide, tungsten carbide, titanium carbide, boron carbide, and/or boron nitride. These materials, as well as the materials forming the spaced-apart structures 158, can be selected on the basis of several properties including corrosion resistance and/or compressive loading. For example, loading a carbon structure with any of the foregoing carbides or nitrides can produce a compressive structure. An advantage of a compressive structure is that it is less subject to corrosion than is a structure that is under tensile forces. In addition, the inherent corrosion resistance of the constituents of the structure (e.g., the foregoing carbides and nitrides) can be enhanced because, under compression, the structure is less permeable to corrosive agents, including steam which may well be present as a reactant in the reaction zone 112 and as a constituent of the combustion products 105 in the passage 118. The foregoing constituents can be used alone or in combination with phosphorus, calcium fluoride and/or another phosphorescent material so that the energy re-radiated by the re-radiative material 152 may be delayed. This feature can smooth out at least some irregularities or intermittencies with which the radiant energy is supplied to the reaction zone 112.

Another suitable re-radiative material 152 includes spinel or another composite of magnesium and/or aluminum oxides. Spinel can provide the compressive stresses described above and can shift absorbed radiation to the infrared so as to facilitate heating the reaction zone 112. For example, sodium or potassium can emit visible radiation (e.g., red/orange/yellow radiation) that can be shifted by spinel or another alumina-bearing material to the IR band. If both magnesium and aluminum oxides, including compositions with colorant additives such as magnesium, aluminum, titanium, chromium, nickel, copper and/or vanadium, are present in the re-radiative material 152, the re-radiative material 152 can emit radiation having multiple peaks, which can in turn allow multiple constituents within the reaction zone 112 to absorb the radiative energy.

The particular structure of the re-radiation component 150 shown in FIG. 3 includes gaps 153 that can allow not only radiation to pass through, but can also allow constituents to pass through. Accordingly, the re-radiation component 150 can also form the transmissive surface 119, which, as described above with reference to FIG. 1, can further facilitate the reaction in the reaction zone 112 by admitting reactants.

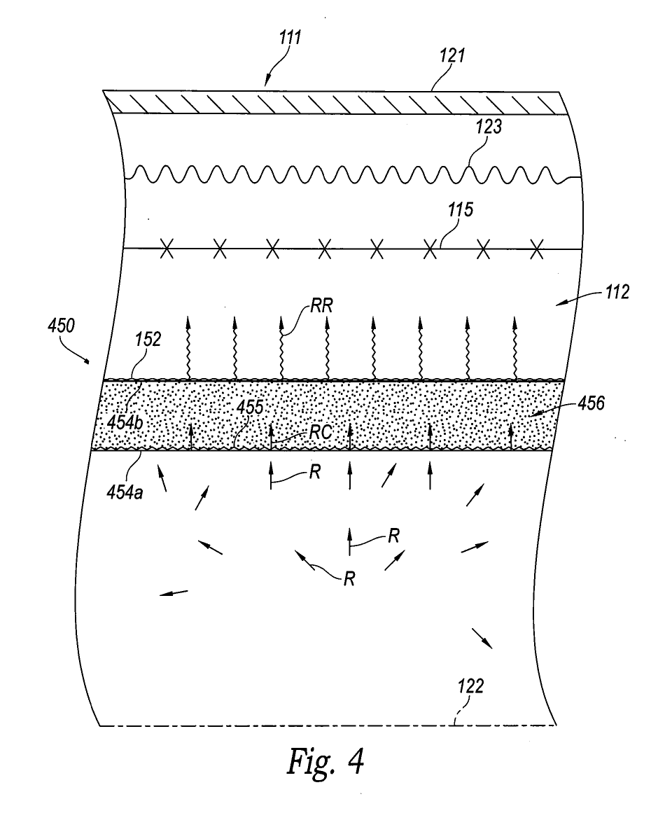

FIG. 4 is a partially schematic illustration of a re-radiation component 450 configured in accordance with another embodiment of the presently disclosed technology. In one aspect of this embodiment, the re-radiation component 450 includes a first surface 454a facing toward the incident radiative energy (indicated by arrows R) and a second surface 454b facing toward the reaction zone 112. The first surface 454a can include absorption features 455, for example, surface features (e.g., pits or wells) that facilitate rapidly and thoroughly absorbing the incident radiation R. Such features can be coated with or otherwise include internally reflecting and extinguishing materials, such as chromium. Other suitable features include dark colors (e.g., black) to enhance radiation absorption. The re-radiation component 450 further includes a conductive volume 456 between the first surface 454a and the second surface 454b. The conductive volume 456 is selected to transmit the energy absorbed at the first surface 454a conductively to the second surface 454b as indicated by arrow RC. Accordingly, the conductive volume 456 can include graphite, diamond, boron nitride, copper, beryllium oxide and/or other strong thermal conductors. The second surface 454b can include any of the re-radiative materials 152 described above. Accordingly, the re-radiative materials 152 re-radiate the radiation, as indicated by arrows RR, into the reaction zone 112 where the radiation enhances the reaction in any of the manners described above.

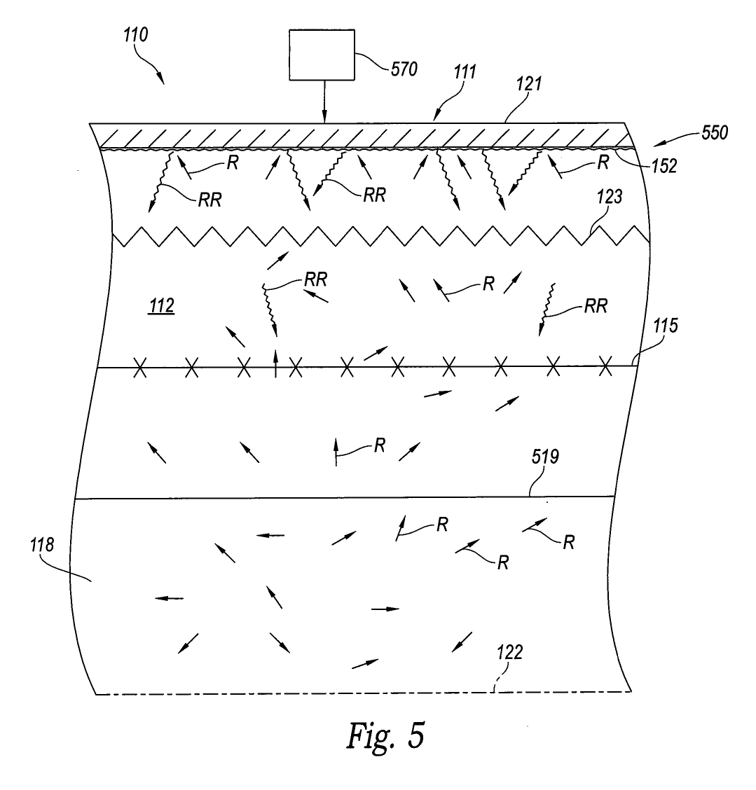

FIG. 5 is a partially schematic illustration of a re-radiation component 550 configured in accordance with yet another embodiment of the technology. In this embodiment, the reactor 110 includes a transmissive surface 519 positioned between the radiative energy (indicated by arrows R) in the passage 118, and the reaction zone 112. The transmissive surface 519 can include glass or another suitable material. The radiant energy R passes through the reaction zone 112 and impinges on the re-radiation component 550 positioned, in this particular embodiment, at or near an outer surface 121 of the reactor vessel 111. The re-radiation component 550 includes a re-radiative material 152 that re-radiates the incident energy as re-radiated energy RR back into the reaction zone 112, where it can enhance the reaction in any of the manners described above.

In at least some embodiments, it may be desirable to allow some of the incident radiative energy R to be reflected without being re-radiated at a new wavelength. Accordingly, the re-radiation component 550 can include regions that are purely reflective and do not have a re-radiative material 152. These regions can have any of a variety of shapes, e.g., strips, checkerboards, and/or others. In further embodiments, it may be desirable to change the degree to which the re-radiation component 550 reflects the incident radiation versus re-radiation, the incident radiation. Accordingly, the reactor 110 can include an actuator 570 that operates to selectively expose or cover reflective portions of the component 550 and/or re-radiative portions of the component 550. In still further embodiments, the wavelength to which the component shifts the incident radiation R can be adjusted, e.g., during the course of a reaction or between reactions, for example if a different reactant or radiation source is introduced into the reactor 110. In such cases, the actuator 570 can adjust any of a variety of suitable parameters that affect the absorptive and/or re-radiative characteristics of the re-radiative material 152. These parameters can include the material temperature which can in turn change the material color. The temperature can be adjusted by heating the material 152, or increasing/reducing the insulation adjacent the material 152. The characteristics of the material 152 can also be changed by passing an electric current through the material, and/or by other techniques.

From the foregoing, it will appreciated that specific embodiments of the technology have been described herein for purposes of illustration, but that various modifications may be made without deviating from the technology. For example, the source of the radiant energy 150 can provide a fluid or other radiant energy emitter other than a combustion products stream. The re-radiation component can include materials other than those expressly described above. The reactions described above can include other hydrocarbons, or hydrogen donors that include constituents other than carbon, for example, hydrogen donors that include boron, nitrogen, silicon, and/or sulfur. Representative reactants include methanol, gasoline, propane, bunker fuel and ethanol. In particular embodiments, the reactors can have overall arrangements other than those described above, while still incorporating transmissive components. The re-radiation component can shift the peak radiant energy wavelength toward the absorption peak of one or more of the reactants and/or one or more of the products.

Certain aspects of the technology described in the context of particular embodiments may be combined or eliminated in other embodiments. For example, the reflective re-radiation component 550 described in the context of FIG. 5 may be combined with the re-radiation components 150, 450 to shift additional radiant energy. The specific features described above in the context of the reactor 110 shown in FIG. 1 (e.g., the heater 123) can be eliminated in at least some embodiments. Further while advantages associated with certain embodiments of the technology have been described in the context of those embodiments, other embodiments may also exhibit such advantages, and not all embodiments need necessarily exhibit such advantages to fall within the scope of the present disclosure. Accordingly, the present disclosure and associated technology can encompass other embodiments not expressly shown or described herein.

To the extent not previously incorporated herein by reference, the present application incorporates by reference in their entirety the subject matter of each of the following materials: U.S. patent application Ser. No. 12/857,553, filed on Aug. 16, 2010 and titled SUSTAINABLE ECONOMIC DEVELOPMENT THROUGH INTEGRATED PRODUCTION OF RENEWABLE ENERGY, MATERIALS RESOURCES, AND NUTRIENT REGIMES; U.S. patent application Ser. No. 12/857,553, filed on Aug. 16, 2010 and titled SYSTEMS AND METHODS FOR SUSTAINABLE ECONOMIC DEVELOPMENT THROUGH INTEGRATED FULL SPECTRUM PRODUCTION OF RENEWABLE ENERGY; U.S. patent application Ser. No. 12/857,554, filed on Aug. 16, 2010 and titled SYSTEMS AND METHODS FOR SUSTAINABLE ECONOMIC DEVELOPMENT THROUGH INTEGRATED FULL SPECTRUM PRODUCTION OF RENEWABLE MATERIAL RESOURCES USING SOLAR THERMAL; U.S. patent application Ser. No. 12/857,502, filed on Aug. 16, 2010 and titled ENERGY SYSTEM FOR DWELLING SUPPORT; Attorney Docket No. 69545-8505.US00, filed on Feb. 14, 2011 and titled DELIVERY SYSTEMS WITH IN-LINE SELECTIVE EXTRACTION DEVICES AND ASSOCIATED METHODS OF OPERATION; U.S. Patent Application No. 61/401,699, filed on Aug. 16, 2010 and titled COMPREHENSIVE COST MODELING OF AUTOGENOUS SYSTEMS AND PROCESSES FOR THE PRODUCTION OF ENERGY, MATERIAL RESOURCES AND NUTRIENT REGIMES; Attorney Docket No. 69545-8601.US00, filed on Feb. 14, 2011 and titled CHEMICAL PROCESSES AND REACTORS FOR EFFICIENTLY PRODUCING HYDROGEN FUELS AND STRUCTURAL MATERIALS, AND ASSOCIATED SYSTEMS AND METHODS; Attorney Docket No. 69545-8602.US00, filed on Feb. 14, 2011 and titled REACTOR VESSELS WITH TRANSMISSIVE SURFACES FOR PRODUCING HYDROGEN-BASED FUELS AND STRUCTURAL ELEMENTS, AND ASSOCIATED SYSTEMS AND METHODS; Attorney Docket No. 69545-8604.US00, filed on Feb. 14, 2011 and titled THERMAL TRANSFER DEVICE AND ASSOCIATED SYSTEMS AND METHODS; Attorney Docket No. 69545-8605.US00, filed on Feb. 14, 2011 and titled CHEMICAL REACTORS WITH ANNULARLY POSITIONED DELIVERY AND REMOVAL DEVICES, AND ASSOCIATED SYSTEMS AND METHODS; Attorney Docket No. 69545-8606.US00, filed on Feb. 14, 2011 and titled REACTORS FOR CONDUCTING THERMOCHEMICAL PROCESSES WITH SOLAR HEAT INPUT, AND ASSOCIATED SYSTEMS AND METHODS; Attorney Docket No. 69545-8608.US00, filed on Feb. 14, 2011 and titled INDUCTION FOR THERMOCHEMICAL PROCESS, AND ASSOCIATED SYSTEMS AND METHODS; Attorney Docket No. 69545-8611.US00, filed on Feb. 14, 2011 and titled COUPLED THERMOCHEMICAL REACTORS AND ENGINES, AND ASSOCIATED SYSTEMS AND METHODS; U.S. Patent Application No. 61/385,508, filed on Sep. 22, 2010 and titled REDUCING AND HARVESTING DRAG ENERGY ON MOBILE ENGINES USING THERMAL CHEMICAL REGENERATION; Attorney Docket No. 69545-8616.US00, filed on Feb. 14, 2011 and titled REACTOR VESSELS WITH PRESSURE AND HEAT TRANSFER FEATURES FOR PRODUCING HYDROGEN-BASED FUELS AND STRUCTURAL ELEMENTS, AND ASSOCIATED SYSTEMS AND METHODS; Attorney Docket No. 69545-8701.US00, filed on Feb. 14, 2011 and titled ARCHITECTURAL CONSTRUCT HAVING FOR EXAMPLE A PLURALITY OF ARCHITECTURAL CRYSTALS; U.S. patent application Ser. No. 12/806,634, filed on Aug. 16, 2010 and titled METHODS AND APPARATUSES FOR DETECTION OF PROPERTIES OF FLUID CONVEYANCE SYSTEMS; Attorney Docket No. 69545-8801.US01, filed on Feb. 14, 2011 and titled METHODS, DEVICES, AND SYSTEMS FOR DETECTING PROPERTIES OF TARGET SAMPLES; Attorney Docket No. 69545-9002.US00, filed on Feb. 14, 2011 and titled SYSTEM FOR PROCESSING BIOMASS INTO HYDROCARBONS, ALCOHOL VAPORS, HYDROGEN, CARBON, ETC.; Attorney Docket No. 69545-9004.US00, filed on Feb. 14, 2011 and titled CARBON RECYCLING AND REINVESTMENT USING THERMOCHEMICAL REGENERATION; Attorney Docket No. 69545-9006.US00, filed on Feb. 14, 2011 and titled OXYGENATED FUEL; U.S. Patent Application No. 61/237,419, filed on Aug. 27, 2009 and titled CARBON SEQUESTRATION; U.S. Patent Application No. 61/237,425, filed on Aug. 27, 2009 and titled OXYGENATED FUEL PRODUCTION; Attorney Docket No. 69545-9102.US00, filed on Feb. 14, 2011 and titled MULTI-PURPOSE RENEWABLE FUEL FOR ISOLATING CONTAMINANTS AND STORING ENERGY; U.S. Patent Application No. 61/421,189, filed on Dec. 8, 2010 and titled LIQUID FUELS FROM HYDROGEN, OXIDES OF CARBON, AND/OR NITROGEN; AND PRODUCTION OF CARBON FOR MANUFACTURING DURABLE GOODS; and Attorney Docket No. 69545-9105.US00, filed on Feb. 14, 2011 and titled ENGINEERED FUEL STORAGE, RESPECIATION AND TRANSPORT.

1. A chemical reactor, comprising:
a reactor vessel having a reaction zone;
a reactant supply coupled to the reactor vessel to direct a reactant into the reaction zone, the reactant having a peak absorption wavelength range over which it absorbs more energy than at non-peak wavelengths; and
a re-radiation component positioned at the reaction zone to receive radiation over a first spectrum having a first peak wavelength range and re-radiate the radiation into the reaction zone over a second spectrum having a second peak wavelength range different than the first and closer than the first to the peak absorption wavelength range of the reactant.

2. The reactor of claim 1 wherein the second peak wavelength range overlaps with the peak absorption wavelength range of the reactant.

3. The reactor of claim 1 wherein the peak absorption wavelength range has a peak value and wherein the second peak wavelength range has an approximately equal peak value.

4. The reactor of claim 1 wherein the component includes a plurality of spaced-apart structures separated by gaps, and wherein the gaps are oriented to pass radiation at a first orientation into the reaction zone.

5. The reactor of claim 4 wherein individual structures have a coating of re-radiative material positioned to absorb and re-radiate radiation that is at a second orientation different than the first orientation.

6. The reactor of claim 4 wherein the structures include graphene layers.

7. The reactor of claim 4 wherein individual structures include a self-organizing material formed from atoms of at least one of the following elements: carbon, nitrogen, boron, silicon and sulfur.

8. The reactor of claim 1, further comprising a radiant energy source, and wherein the re-radiation component is positioned between the reaction zone and the radiant energy source.

9. The reactor of claim 8 wherein the re-radiation component has:
a first surface facing toward the radiant energy source;
a second surface facing toward the reaction zone; and
a conductive path between the first and second surfaces, and wherein the first surface receives radiation over the first frequency range and the second surface re-radiates radiation over the second frequency range.

10. The reactor of claim 8 wherein the first surface includes multiple apertures positioned to internally reflect and extinguish incident radiation.

11. The reactor of claim 1 wherein the reactant includes at least one of methane and methanol.

12. The reactor of claim 1 wherein the reactant includes a hydrocarbon.

13. The reactor of claim 1 wherein the re-radiative material includes at least one of a fluorescent material and a phosphorescent material.

14. The reactor of claim 1 wherein the re-radiative material includes a spinel.

15. A method for manufacturing a chemical reaction chamber, comprising:
selecting chemical reactants for use in a reaction zone of a reaction chamber to include a hydrogen donor, at least one of the reactants, or a resulting product, or both, having a peak absorption wavelength range over which it absorbs more energy than at non-peak wavelengths; and
selecting a re-radiation component positioned at the reaction zone to receive radiation over a first spectrum having a first peak wavelength range and re-radiate the radiation over a second spectrum having a second peak wavelength range different than the first and closer than the first to the peak absorption wavelength range.

16. The method of claim 15, further comprising selecting the component to form a boundary separating a region internal to the reaction zone from a region external to the reaction zone.

17. The method of claim 15 wherein selecting the component includes selecting the component to absorb radiation and re-radiate the radiation from a surface facing toward the reaction zone.

18. The method of claim 15 wherein selecting the component includes selecting the component to have a first surface facing away from the reaction zone, a second surface facing toward the reaction zone and a conductive volume between the first and second surfaces, and wherein the method further comprises:
selecting the first surface to absorb radiation over the first spectrum; and
selecting the second surface to re-radiate the radiation over the second spectrum.

19. The method of claim 15, further comprising selecting the component to include:
spaced-apart, generally parallel structures positioned to pass radiation oriented with the spaces between the layers; and
a re-radiative material on the spaced-apart layers.

20. The method of claim 15 wherein selecting the component includes selecting the component to re-radiate the radiation over a second spectrum having a second peak wavelength range that overlaps the peak absorption range of the reactant.

21-28. (canceled)
